(19) United States
(12) Patent Application Publication
(10) Pub. No.: US 2012/0199329 A1
(43) Pub. Date: Aug. 9, 2012

(54) SPIRAL HEAT EXCHANGER

(75) Inventors: Charles Bonnafous, Nevers (FR); Isabelle Planat, Parigny Les Vaux (FR)

(73) Assignee: ALFA LAVAL CORPORATE AB, Lund (SE)

(21) Appl. No.: 13/266,252

(22) PCT Filed: Apr. 28, 2010
(86) PCT No.: PCT/EP10/55710

§ 371 Date: Apr. 26, 2012

(30) Foreign Application Priority Data
May 11, 2009 (EP) 09159837.5

(51) Int. Cl. F28D 7/04; B23P 15/26

(52) U.S. Cl. 165/165; 29/890.03

(57) ABSTRACT

The invention relates to a spiral heat exchanger (1) including a spiral body (2) formed by at least two spiral sheet (10a, 10b) wounded to form the spiral body forming at least a first spiral-shaped flow channel for a first medium and a second spiral-shaped flow channel for a second medium, wherein the spiral body is enclosed by a substantially cylindrical shell (2) being provided with connecting elements (8a, 8b, 9a, 9b) communicating with the first flow channel and the second flow channel, where the at least two spiral sheet also forms the centre of the spiral body, where each spiral sheet comprise a first sheet portion (12a, 12b) and where the flow channels comprise a second sheet portion (13a, 13b), and where the first sheet portion is made of a material that is thicker than the second sheet portion.

The present invention refers generally to spiral heat exchangers allowing a heat transfer between two fluids at different temperatures for various purposes. Specifically, the invention relates to a spiral heat exchanger having a spiral body made by an improved forming method.

### BACKGROUND OF INVENTION

Conventionally, spiral heat exchangers are manufactured by means of a winding operation. The two sheets are welded together at a respective end, wherein the welded joint will be comprised in a center portion of the sheets. The two sheets are wound around one another by use of a retractable mandrel or the like to form the spiral element of the sheets so as to delimit two separate passages or flow channels. Distance members, having a height corresponding to the width of the flow channels, are attached to the sheets.

After retraction of the mandrel, two inlet/outlet channels are formed in the center of the spiral element. The two channels are separated from each other by the center portion of the sheets. A shell is formed by the outer turn of the spiral element. The side ends of the spiral element are processed, wherein the spiral flow channels may be laterally closed at the two side ends in various ways. Typically, a cover is attached to each of the ends. One of the covers may include two connection pipes extending into the center and communicating with a respective one of the two flow channels. At the radial outer ends of the spiral flow channels a respective header is welded to the shell or the spiral element form an outlet/inlet member to the respective flow channel.

Alternatively a tubular center can be used instead of forming the center of the spiral body by a winding process. The sheets for forming the channels are welded onto the tubular center. After welding the sheets onto the tubular center the sheets are wound by a winding machine to form the fluid channels.

One problem with the wounded center of earlier spiral heat exchangers is that the center can be week against fatigue due to the fact that the sheet forming the center is the same as the sheet forming the channels. One problem with the tubular center solution is that due to the low quantity the tubular centers are expensive and difficult to purchase, especially for tubular centers made of other materials than the stainless steel alloy of SAE grade 316L and 304.

### DISCLOSURE OF INVENTION

The object of the present invention is to overcome the problems mentioned above with the prior art spiral heat exchangers. More specifically, it is aimed at a spiral heat exchanger which the simplified solution for the center of the spiral body having high fatigue resistance and which will be cheaper to manufacture.

This object is achieved by a spiral heat exchanger including a spiral body formed by at least two spiral sheets wound to form the spiral body forming at least a first spiral-shaped flow channel for a first medium and a second spiral-shaped flow channel for a second medium, wherein the spiral body is enclosed by a substantially cylindrical shell being provided with connecting elements communicating with the first flow channel and the second flow channel, and where distance members are provided to separate the first and second flow channel, where the at least two spiral sheet also forms the center of the spiral body, where each spiral sheet comprise a first sheet portion forming the center of the spiral body and a second sheet portion forming the flow channels, and where the first sheet portion is made of a material that is thicker than the second sheet portion.

According to a first aspect of the invention the first sheet portion and the second sheet portion are welded together and that a transition portion provided between the two sheet portions is tapered from the first sheet portion to the second sheet portion.

According to another aspect of the invention the center of the spiral body is sealed and that the outlet/inlets of the first flow channel and the second flow channel are located in close proximity to the spiral center.

According to yet another aspect of the invention the each end of the spiral center of the spiral body is sealed by a cover.

According to a further aspect of the invention the spiral center of the spiral body and the first wound of the spiral body are retracted in relation to the rest of the spiral body and the flow channels to create an inlet or outlet, respectively, in close proximity to the spiral center of the spiral body.

According to a further aspect of the invention the distance members are provided on the second sheet portion.

According to yet a further aspect of the invention the first sheet portion is preferably made of a material having a thickness between 6 and 8 mm, and where the second sheet portion is preferably made of a material having a thickness between 2 and 2.5 mm.

A further object of the invention is to form a center of the spiral body in a spiral heat exchanger having high fatigue resistance and which will cheaper to manufacture.

This object is achieved with a method of making a spiral body of spiral heat exchanger including the following steps:

insert two sheets from opposite sides into a retractable mandrel, where the two sheets comprise a first sheet portion making up the centre of the spiral body and a second sheet portion making up the flow channels of the spiral body, and where the first sheet portion is made of a material that is thicker than the second sheet portion;

winding the two sheets to form a spiral body in a winding machine;

welding each sheets to the other sheet at position to form the spiral center; and weld covers to each end of the spiral center to seal off the spiral center.

According to a further aspect of the invention: are covers welded to each end of the spiral center to seal off the spiral center, the spiral center formed by the first sheet portions being retracted compared to the second sheet portion making up the flow channels creating an inlet or outlet, respectively, in close proximity to the spiral center of the spiral body.

Further aspects of the invention is apparent from the dependent claims and the description

### BRIEF DESCRIPTION OF THE DRAWINGS

Further objects, features and advantages will appear from the following detailed description of several embodiments of the invention with reference to the drawings, in which:

FIG. 1 is a perspective view of a spiral heat exchanger;

FIG. 2 is a schematic overview of a spiral heat exchanger;

FIG. 3 is a cross sectional view of a centre of a prior art spiral heat exchanger;

FIG. 4 is a cross sectional view of a centre of a prior art spiral heat exchanger;

FIG. 5 is a first cross sectional view of a centre of a spiral heat exchanger according to the present invention; and

FIG. 6 is a perspective view of a spiral heat exchanger according to the present invention.

### DETAILED DESCRIPTION OF EMBODIMENTS

A spiral heat exchanger includes at least two spiral sheets extending along a respective spiral-shaped path around a common center axis and forming at least two spiral-shaped flow channels, which are substantially parallel to each other, wherein each flow channel includes a radially outer orifice, which enables communication between the respective flow channel and a respective outlet/inlet conduit and which is located at a radially outer part of the respective flow channel with respect to the center axis, and a radially inner orifice, which enables communication between the respective flow channel and a respective inlet/outlet chamber, so that each flow channel permits a heat exchange fluid to flow in a substantially tangential direction with respect to the center axis, wherein the center axis extends through the inlet/outlet chambers at the radially inner orifice. Distance members, having a height corresponding to the width of the flow channels, may be attached to the sheets.

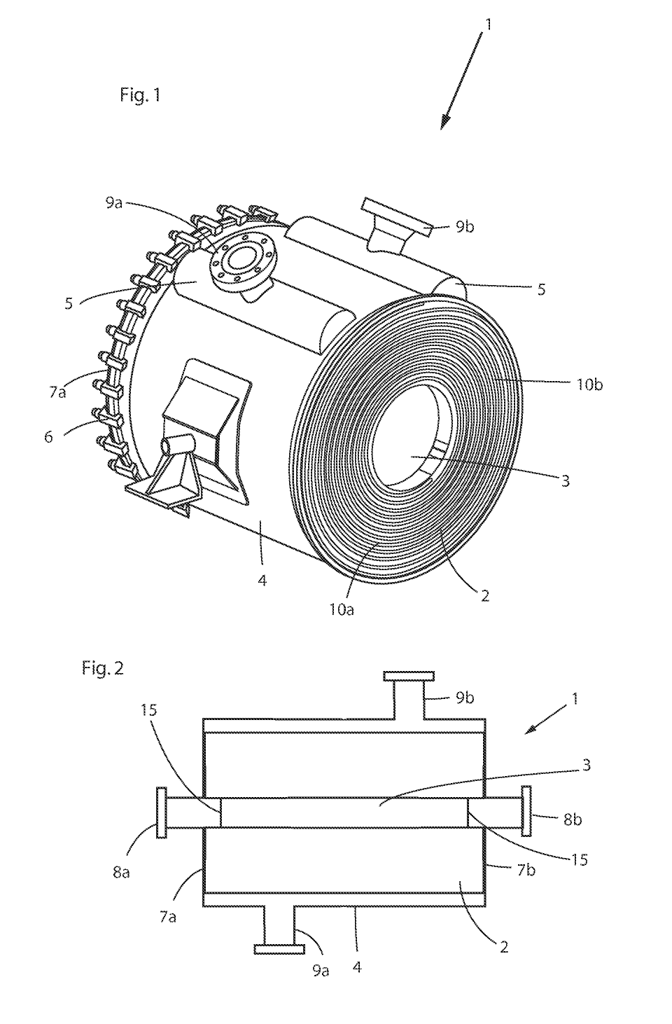

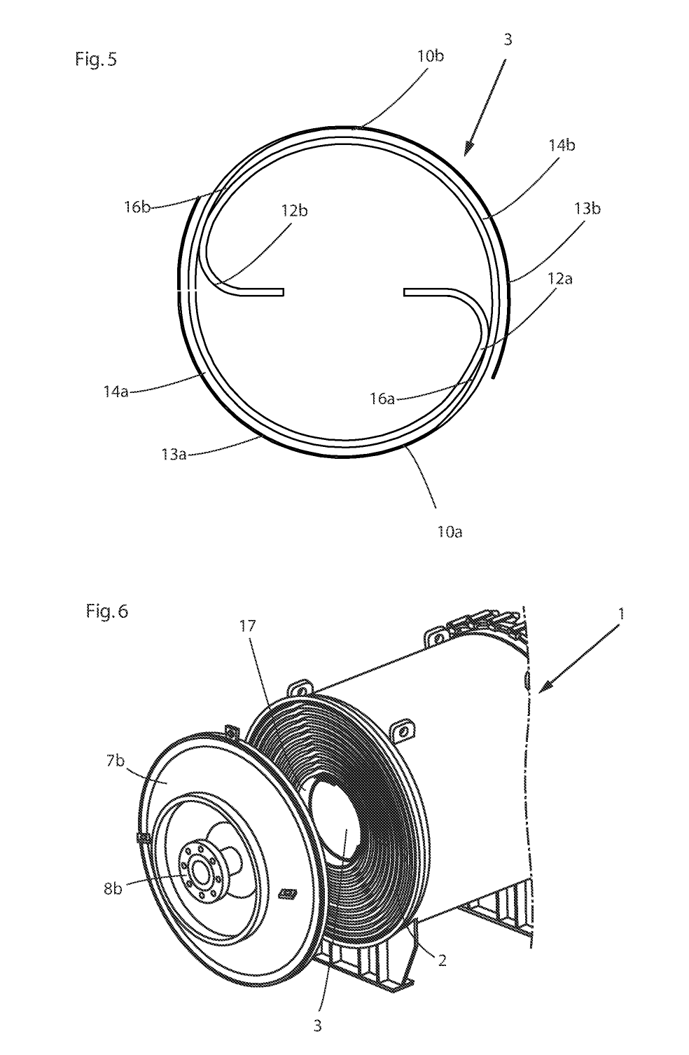

In FIG. 1 is shown a perspective view of a spiral heat exchanger 1 according to the present invention. The spiral heat exchanger 1 includes a spiral body 2. The sheets 10a, 10b are provided with distance member (not shown) attached to the sheets or formed in the surface of the sheets. The distance members serve to form the flow channels 14a, 14b (see FIG. 5) between the sheets 10a, 10b and have a height corresponding to the width of the flow channels. In FIG. 1 the spiral body 2 only has been schematically shown with a number of wounds, but it is obvious that it may include further wounds and that the wounds are formed from the center of the spiral body 2 all the way out to the peripheral of the spiral body 2. The spiral body 2 may be enclosed by a separate shell 4, but normally the sheets forming the spiral body 2 also constitutes the shell by the outer wound of the sheet. The center 3 of the spiral heat exchanger 1 is covered by a cover 15 (schematically shown in FIG. 2), which is welded onto the spiral body 2. The fluid channels 14a, 14b are covered by lids or end covers 7a, 7b, which are removably attached to the spiral heat exchanger by bolt 6 or similar.

One of the covers 7a, 7b may include two connection pipes 8a, 8b extending into the center and communicating with a respective one of the two flow channels, or each of the covers 7a, 7b may include a connection pipe 8a, 8b, extending into the center and communicating with a respective one of the two flow channels. At the radial outer ends of the spiral flow channels 14a, 14b, respectively a header 5 it is welded to the shell 4 or the spiral element 9a, 9b forming an outlet/inlet member to the respective flow channel 14a, 14b.

The spiral heat exchanger 1 is further provided with gaskets, where each gasket being arranged between the end portions of the spiral body 2 and the inner surface of the end covers 7a, 7b to seal off the flow channels 14a, 14b from external leakage and to prevent bypass between the different wound so r turns of the same flow channel. The gasket can be formed as a spiral similar to the spiral of the spiral body 2, is then squeezed onto each wound of the spiral body 2. Alternatively the gaskets are squeezed between the spiral body 2 and the inner surface of the end cover 7a, 7b. The gaskets can also be configured in other ways as long as the sealing effect is achieved.

Although it has not been mentioned it clear for a man skilled in the art that the outer surface of the spiral body 2 is normally provided with studs or distance members) that supports against the inner surface of the shell to resist the pressure of the working fluids of the spiral heat exchanger 1. In certain applications there is no need to studs in the flow channels.

As mentioned above the center of spiral body 2 is formed by winding two sheets 10a, 10b of metal around a retractable mandrel 11 (not shown). Each sheet 10a, 10b of metal comprises a first thicker sheet portion 12a, 12b and a second thinner sheet portion 13a, 13b. The first thicker portion 12a, 12b, which only constitutes a shorter portion of the sheet 10a, 10b of metal, is used to form the center 3 of the spiral body 2. The second thinner portion 13a, 13b constitutes a longer portion of the sheet 19a, 10b of metal that is used to form the flow channels 14a, 14b of the spiral body 2. The length of the respective portion depends on the diameter of the center 3 and the length of the fluid channels, respectively. The two portions of each sheet of metal are welded together, and a transition section between the two portions are tapered to have a smooth transition from the thicker sheet portion 12a, 12b to the thinner sheet portion 13a, 13b. According to one example the first thicker portion of the sheet of metal has a thickness of about 6-8 mm and the second thinner portion of the sheet of metal has a thickness of about 2-2.5 mm, but other examples of the thickness are also possible as long as the center 3 has a good resistance against fatigue and that a good thermal exchange is created between the two fluid channels.

The center 3 of the spiral body 2 is formed by inserting each first thicker portion of the two sheets of metal into opposite slits of the retractable mandrel. The sheets of metal are inserted approximately ⅕ to ⅓ of the diameter of the mandrel into the slits. After the insertion of the sheets of metal the winding machine winds the sheets to form the spiral body 2. The transition section between the first thicker portion 12a, 12b of the sheet of metal and the second thinner portion 13a, 13b of the sheet of metal is approximately located after little more than one half turn. After the winding machine has completed the winding of the sheets of metal the spiral body 2 is removed from the winding machine and the retractable mandrel is removed. The spiral body 2 is moved to a welding station for manually or by a welding machine seal or close up the two fluid channels 14a, 14b from each other and to seal the spiral center 3 from the fluid channels 14a, 14b, by welding the together the thicker sheet portions 12a, 12b to each other at a position 16a, 16b. The position 16a substantially equals a position, where the thicker sheet portion 12a has completed just more than a half turn and after thicker sheet portion 12a have reached the other thicker portion 12b and begins to taper to the thinner sheet portion 13a. The position 16b substantially equals a position where the thicker sheet portion 12b has completed just more than a half turn and after thicker portion 12b have reached the other thicker portion 12a and begins to taper to the thinner sheet portion 13b. Finally the lids or covers 15 (schematically shown is FIG. 2) are welded onto each end opening of the spiral center 3 to achieve a very resistant and sealed spiral center 3.

The spiral center 3 and the first wound of the flow channels 14a, 14b are in each end retracted compared with the remaining wounds of the fluid channels 14a, 14b to enable fluids to enter/exit the spiral heat exchanger since the spiral center 3 is sealed by lids/covers 15. The measure of the spiral center retraction 17 is depending on the required fluid flow, and in a preferred embodiment the retraction amounts to about 90 mm, but obviously other measures are also possible.

To close the two fluid channels 14a, 14b from each other and to prevent mixing of the fluid of the respective flow channels the outermost edges of the spiral body 2 are folded so that every second wound opening is closed and that the fold is welded to secure the closure. This is done alternately on the two ends of the spiral body 2 so that e.g. in end of spiral body 2 later covered by the cover 7a the fluid channel 14b is closed and the in end of spiral body 2 later covered by the cover 7b the fluid channel 14a is closed. As mentioned above gaskets are being arranged between the end portions of the spiral body 2 and the inner surface of the end covers 7a, 7b to seal off and to guide the fluid through the flow channels.

The functionality of the spiral heat exchanger 1 is as follows: A first medium enters the spiral heat exchanger 1 through the first connection element 8a arranged in the center of the cover 7a of the spiral heat exchanger 1 and formed as an inlet and where first connection element 8a is connected to a piping arrangement. The first connection element 8a communicates with a first flow channel 14a of the spiral body 2, which “starts” at the first open wound outside the spiral center 3 and the first medium is transported through the first flow channel 14a to the second communication element 9a, which is arranged on the periphery of the spiral body 2 and on the shell 4, formed as an outlet, where the first medium leaves the spiral heat exchanger 1. The second communication element 9a is connected to a piping arrangement for further transportation of the first medium.

A second medium enters spiral heat exchanger 1 through the second connection element 9b, which is arranged on the outer periphery of the spiral body 3 and the shell 4, formed as an inlet, the second connection element 9b being connected to a piping arrangement. The second connection element 9b communicates with a second flow channel 14b of the spiral body 2 and the first medium is transported through the second flow channel 14 b to the first connection element 8b formed as an outlet, where the second medium leaves the spiral heat exchanger 1. The first connection element 8b, which is arranged on the center of the cover 7a of the spiral heat exchanger 1, is further connected to a piping arrangement for further transportation of the second medium.

Inside the spiral body 2 a heat exchange will occur between the first and second medium, so that one medium is heated and the other medium is cooled. Depending on the specific use of the spiral heat exchanger 1 the selection of the two mediums will vary. In the above it has been described as the two mediums circulate in opposite directions through the spiral heat exchanger 1, but it is apparent that they may also circulate parallel directions.

In the above description the term connecting element has been used as an element connected to spiral heat exchanger and more specifically to the flow or fluid channels 14a, 14b of the spiral heat exchanger 1, but it should be understood that the connecting element is a connection pipe or similar that typically are welded onto the spiral heat exchanger and may include means for connecting further piping arrangements to the connecting element.

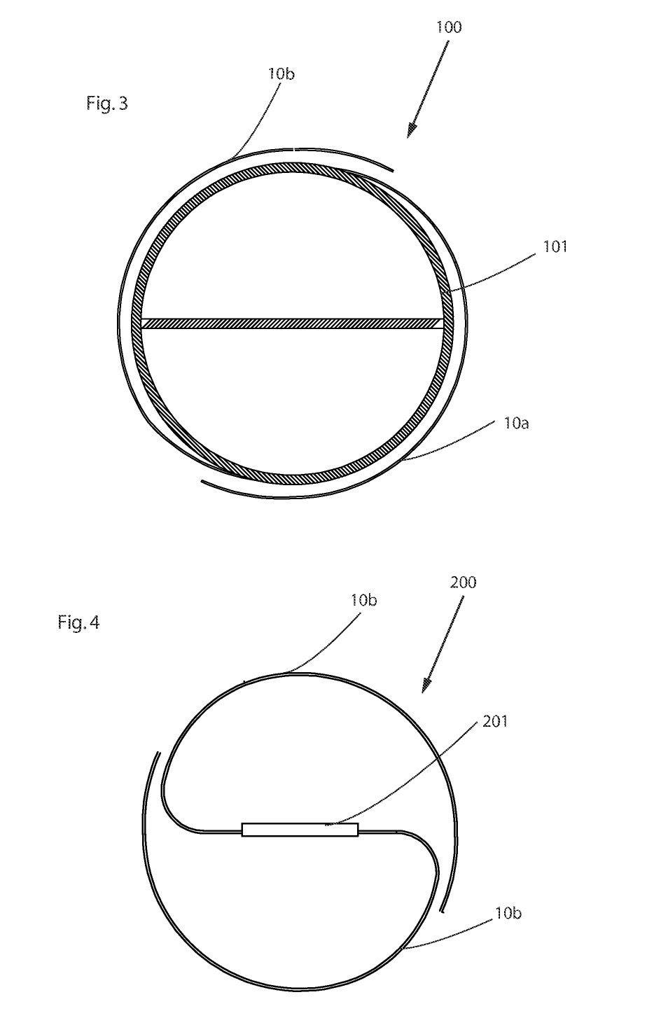

In FIG. 3 is shown the prior art solution of the spiral center 100 made from a tubular center 101 with sheets for forming the flow channels welded onto thereon. In FIG. 4 is shown the prior art solution of the spiral center 200 made from two sheet that welded together 201 and wound for forming the spiral center and the flow channels.

The invention is not limited to the embodiments described above and shown on the drawings, but can be supplemented and modified in any manner within the scope of the invention as defined by the enclosed claims.

1.-9. (canceled)

10. A spiral heat exchanger comprising a spiral body formed by at least two spiral sheets wound to form the spiral body and forming at least a first spiral-shaped flow channel for a first medium and a second spiral-shaped flow channel for a second medium, the spiral body being enclosed by a substantially cylindrical shell and being provided with connecting elements communicating with the first flow channel and the second flow channel, distance members in the form of studs separate the first and second flow channels, and removable end covers cover the open ends of the shell, wherein the at least two spiral sheets also form a spiral center of the spiral body, each spiral sheet comprises a first sheet portion forming the spiral center of the spiral body and a second sheet portion forming the flow channels, and wherein the first sheet portion is made of a material that is thicker than the second sheet portion.

11. The spiral heat exchanger according to claim 10, wherein the first sheet portion and the second sheet portion are welded together and a transition portion provided between the two sheet portions is tapered from the first sheet portion to the second sheet portion.

12. The spiral heat exchanger according to claim 10 or claim 11, wherein the spiral center of the spiral body is sealed and at least one of the connecting elements of the first flow channel and of the second flow channel is located in close proximity to the spiral center.

13. The spiral heat exchanger according to claim 12, wherein each end of the spiral center of the spiral body is sealed by a cover.

14. The spiral heat exchanger according to claim 13, wherein the spiral center of the spiral body and the first wound of the spiral body are retracted in relation to the rest of the spiral body and the flow channels to create one of the connecting elements, respectively, in close proximity to the spiral center of the spiral body.

15. The spiral heat exchanger according claim 10, wherein the distance members are provided on the second sheet portion.

16. The spiral heat exchanger according to claim 11, wherein the first sheet portion is made of a material having a thickness between 6 and 8 mm, and wherein the second sheet portion is made of a material having a thickness between 2 and 2.5 mm.

17. The spiral heat exchanger according to claim 13, wherein the spiral center of the spiral body and the first wound of the spiral body are retracted in relation to the rest of the spiral body and the flow channels to create one of the connecting elements, respectively, between the spiral center and an end cover covering the flow channels.

18. A method of making a spiral body of a spiral heat exchanger according to claim 10 or claim 11, comprising:
inserting two sheets from opposite sides into a retractable mandrel, wherein each of the two sheets comprises a first sheet portion making up a spiral center of the spiral body and a second sheet portion making up flow channels of the spiral body, and wherein the first sheet portion is made of a material that is thicker than the second sheet portion;
winding the two sheets to form the spiral body in a winding machine;
welding each sheet to the other sheet at a position to form the spiral center; and
welding covers to each end of the spiral center to seal off the spiral center.

19. The method of making the spiral body of the spiral heat exchanger according to claim 18, wherein:
the spiral center formed by the first sheet portion is retracted compared to the second sheet portion and making up the flow channels creating connecting elements, respectively, are in close proximity to the spiral center of the spiral body.
